(19) United States
(12) Patent Application Publication
(10) Pub. No.: US 2025/0158967 A1
(43) Pub. Date: May 15, 2025

(54) SYSTEM AND METHOD FOR USER COMMUNICATION WITH PRIVACY CONTROL

(71) Applicant: TRRUER DYNAMICS LTD, TEL AVIV-YAFO (IL)

(72) Inventors: Orr DULEV, TEL AVIV-YAFO (IL); Abhiroop BRAHMA, TEL AVIV-YAFO (IL)

(21) Appl. No.: 18/942,790

(22) Filed: Nov. 11, 2024

(30) Foreign Application Priority Data
Nov. 12, 2023 (IL) 308501

(51) Int. Cl. H04L 9/40; G06F 9/451; G06F 21/62; H04L 65/1069

(52) U.S. Cl. CPC H04L 63/0421; G06F 9/451; G06F 21/6254; H04L 65/1069

(57) ABSTRACT

A GUI control system including a processor to execute code for receiving indications from users about profiles of interest presented to the users by a GUI executed on respective user devices, where each user has corresponding profile information presentable by the GUI, detecting couples of mutually interested users that indicated each other's profiles as profiles of interest, for each couple, once predetermined conditions is/are fulfilled, adding in the GUI an anonymous/alternative representation of a matched user in a match page of the other matched user, and initiating a conversation between the matched users by opening a conversation in the matches page in the GUI, where the anonymous/alternative representation conceals the represented user's full/public profile from the other user, and once predetermined conditions is/are fulfilled, changing the anonymous/alternative representation to a full representation by loading all the profile information and/or photos of the represented user to the match page.

### FIELD

The invention, in some embodiments thereof, relates to communication systems and particularly, but not exclusively, to a system and method for matching based on selection of user profiles.

### BACKGROUND

Known matchmaking applications and websites base the matchmaking on publicly open user profiles, in which users may usually review self-descriptions and/or photos of other users. Based on the open profiles, users decide with which users they want to communicate and/or meet.

The information included in the open profiles is usually of a superficial kind and doesn't enable assessment of the person behind the profile. However, users tend to rely on this information when deciding with which user to communicate and/or meet. Therefore, users of such applications will communicate and/or meet with users who present themselves better in the self-descriptions and look better in the photos, even though they can find more suitable matches among users who seem less attractive based on their profiles.

The information presented on this profile is unified and is the same on the publicly open user profile and on the user profile that is presented after a couple of users showed mutual interest in communicating and/or meeting with each other. The users have no option of deciding what to present to who, but only whether they will include it in their profile.

As a result, a known phenomenon across known matchmaking applications and websites is that users collect other users as a form of medals and achievements instead of getting to know the users who showed mutual interest. Out of these users that were collected the user will decide to communicate and/or meet with users who present themselves better in the self-descriptions and look better in the photos, while ignoring the rest of the users. This phenomenon results with increasing the level of anxiety and depression of the users that were left ignored.

Known matchmaking applications and websites manipulate their users by pushing them more options and make it harder for the users to exhaust the options currently available for each user. As a result, users are prone to not get to know the other user that they had mutual interest with.

### SUMMARY

According to an aspect of some embodiments of this invention there is a system for controlling a graphical user interface (GUI). The system comprising a processor configured to execute code for receiving indications from multiple users about profiles of interest presented to the users by a GUI executed on respective devices of the users, wherein each user has corresponding initial profile information presentable by the GUI, detecting couples of mutually interested users that indicated each other's profiles as profiles of interest, for each couple, after a predetermined condition is fulfilled, adding in the GUI an anonymous representation of a mutually interested user with alternative information in a match page of the other mutually interested user, and initiating a conversation between the mutually interested users by opening a conversation page in the GUI, wherein the anonymous representation conceals the represented user's full profile from the other user, and once a predetermined condition, or more, is fulfilled, changing the anonymous representation to a full representation by loading the full profile information of the represented user to the matches page.

According to some embodiments of the invention, the processor is configured to count time and/or number of words by one or more of the users and/or number of messages and/or lead time between messages, and the conditions are combinations of these parameters; wherein the required number of words and/or messages is at least one of a list comprising varying dynamically based on predetermined conditions, depending on a number of open conversations a user has with profiles of interest, depending on a sentiment of the conversation and depending on the continuousness of the conversation.

In some embodiments, after reaching one or more of these conditions the processor may be configured to execute code for receiving a request for profile revealing from a user participating in a conversation.

In some embodiments of the invention, the conversation page includes an anonymous Voice-Over Internet Protocol (VOIP) call.

In some embodiments of the invention, the matches page includes indication of time left until the end of each conversation, and wherein the time expired the conversation will no longer be available to the users.

In some embodiments of the invention, the conversation page includes an indication of whether a user can request to reveal the profiles and if he or she has requested to reveal the profiles.

In some embodiments of the invention, the processor is configured to execute code for receiving a request for revealing the profiles from a user participating in a conversation, and instruct the GUI to reveal the profiles in case both participating users request revealing of the profiles.

In some embodiments of the invention, the anonymous representation includes an icon representing an unrevealed profile of the other one of the matched users, wherein selection of the icon causes opening of the conversation page at the GUI for a conversation between the matched users.

In some embodiments of the invention, the matches page includes additional icons representing unrevealed profiles of other users mutually interested in the device's user, the icons are presented on the matches page as a gallery of icons, enabling the user to review all his or her matches.

In some embodiments of the invention, the processor is configured to execute code for, once profiles of matched users are revealed, transforming the icon to a profile revealing icon.

In some embodiments of the invention, the processor is configured to execute code for adding an anonymous icon of a matched user in a matches page, wherein selection of the icon opens a conversation page at the GUI for a conversation between the matched users. The matches page may include additional icons representing unrevealed profiles of other matched users in the device's user, with which a conversation was initiated, the icons are presented on the matches page as a gallery of icons, enabling the user to review all his or her conversations.

In some embodiments of the invention, the processor is configured to execute code for deciding which profiles to present to the user based on at least one of a list comprising: user preferences, the profiles users selections, selections of users with similar mind set and the user and/or users with similar mind set behavior.

In some embodiments of the invention, the processor is configured to execute code for sorting profiles of interest and deciding which profiles the user can have a conversation with based on at least one of a list comprising: user preferences, the profiles users selections, selections of users with similar mindset and the user and/or users with similar mindset behavior. The user can communicate with up to a predetermined number of users simultaneously.

In some embodiments of the invention, the processor is configured to execute code for dividing reviewed profiles in two groups of profile cards, one for profiles of interest and one for profiles of no interest.

In some embodiments of the invention, the processor is configured to execute code for replenish reviewed profiles of profiles of no interest, so they could be reviewed again in case a condition is fulfilled and/or the user choose to review these profiles.

According to some embodiments of the invention, the processor is configured to execute code for receiving GPS location data from a user's device and for presenting to this user profiles according to the location data.

According to some embodiments of the invention, the processor is configured to execute code for interfacing with external social media and controlling via the GUI exposure of elements of a social media profile to a mutually interested user.

According to an aspect of some embodiments of the invention there is provided a method for controlling a GUI, the method including receiving indications from multiple users about profiles of interest presented to the users by a GUI executed on respective devices of the users, wherein each user has corresponding initial profile information presentable by the GUI, detecting couples of mutually interested users that indicated each other's profiles as profiles of interest, for each couple, after a predetermined condition is fulfilled, adding in the GUI an anonymous representation of a matched user with alternative information in a match page of the other matched user, and initiating a conversation between the matched users by opening a conversation page in the GUI, wherein the anonymous representation conceals the represented user's full profile from the other user, and once a predetermined condition, or more, is fulfilled, changing the anonymous representation to a full representation by loading the full profile information of the represented user to the matches page.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1, consisting of FIG. 1A, FIG. 1B and FIG. 1C is a schematic diagram of a system for controlling a graphical user interface (GUI) of a matchmaking software application, according to some embodiments of the invention;

FIGS. 2A and 2B, taken together, is a flowchart illustrating a method of controlling a GUI of a matchmaking software application, according to some embodiments of the invention;

FIGS. 3A-3F are schematic illustrations of pages of a GUI according to some embodiments of the invention; and

FIG. 4 is a schematic illustration of the profile reveal button variations of a GUI according to some embodiments of the invention;

FIG. 5 is a screenshot of an exemplary GUI window indicating mutual profile reveal, according to some embodiments of the invention;

FIG. 6 is a screenshot of a profile having a masked image that is presented during the conversation, according to some embodiments of the invention.

### DETAILED DESCRIPTION

Some embodiments of the invention provide a system and method for controlling a graphical user interface (GUI) of a matchmaking software application that facilitates acquaintance based on an anonymous/semi anonymous conversation, rather than based on visual properties.

The GUI enables the system to detect mutual interest between subscribers, for example when two users indicate each other's profiles as profiles of interest. In case a mutual interest is detected, the system initiates in the GUI an anonymous communication between the mutually interested profiles.

Optionally, the system enables an anonymous conversation without revealing the full participating profiles until a certain condition, or more, is fulfilled.

During an ongoing conversation, the system executes a decision function to decide when to allow the conversation's participating users to reveal the corresponding full profile. For example, based on a fulfilled condition, or more, such as a level of activity of the participation users in the conversation, for example, specific combination of the number of messages and/or words they sent each other.

During an ongoing conversation, the system executes a decision function to decide when to reveal the conversation's participating full profiles. For example, based on one condition, or more, such as when revealing requests are received from both participation users.

Once the participating profiles are revealed in the GUI, the participating users may review each other's full profiles. Thus, the GUI enables a user to have an anonymous conversation with a user of interest and thus, for example, to present his or her personality and to assess the personality of the other user apart from visual properties.

Accordingly, some embodiments of the invention provide GUI solutions for managing simultaneous conversations with multiple users, for detection of mutually interested users in an initially anonymous manner, and for facilitating anonymous communications between mutually interested users, until certain conditions are fulfilled for revealing their profiles to each other.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

Some embodiments of the invention provide a system and method for controlling a graphical user interface of a matchmaking software application. The graphical user interface enables a user of the application to communicate anonymously with another user for until a certain condition, or more, is fulfilled. Only when the certain condition, or more, is fulfilled, the users can review each other's full profiles, for example including photos, videos, self-descriptions, biographical details, and/or any other suitable data. Other suitable data may include but are not limited to, for example, answered questions and/or details filled during profile creation process and/or details filled during use such as habits, interests, and alike. Such user interface may facilitate acquaintance based on personality impressions enabled by the anonymous communications, rather than based on superficial properties.

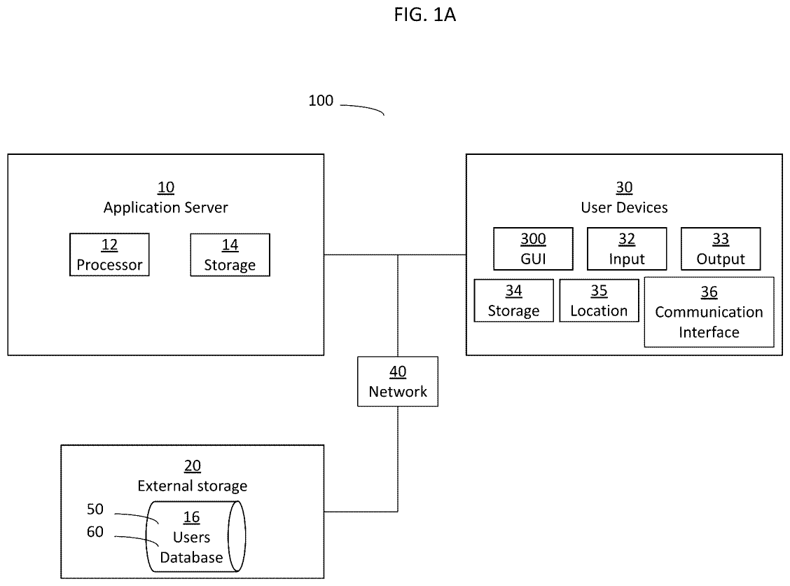

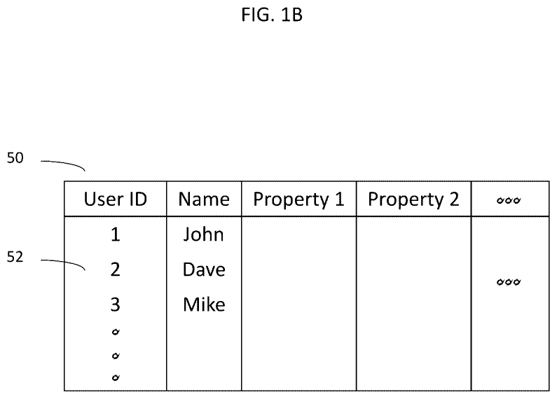

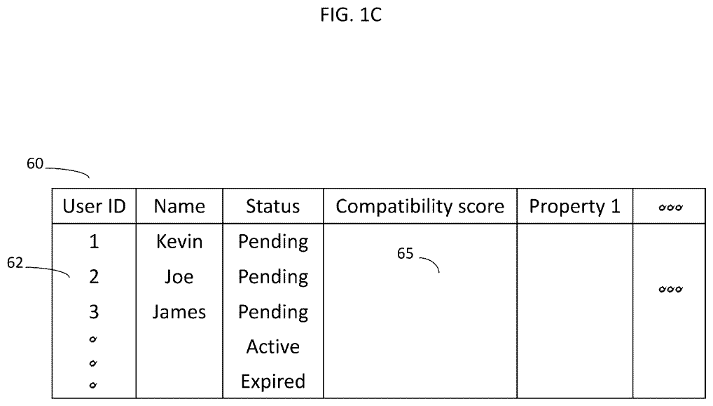

The invention may be implemented as computer software running on a conventional computer system, computer software embodied on a nontransitory storage medium (or media), or otherwise. Referring now to FIG. 1A, which is a schematic illustration of a system 100 for controlling a graphical user interface (GUI) 300 of a matchmaking software application, according to some embodiments of the invention. System 100 includes an application server 10, having a processor 12, storage 14 and a user database 16.

Processor 12 retrieves and executes software instructions stored in storage 14 such as memory, which may be Random Access Memory (RAM) and may control other components to perform the invention. Storage 14 may be used to store program instructions or data or both. Separate external storage 20, such as a mobile disk drive or other non-volatile storage, may provide storage of data or program instructions as well. In one embodiment, external storage 20 provides longer term storage of instructions and data, with storage 14 providing storage for data or instructions that may only be required for a shorter time than that of external storage 20. External storage 20 can also be used to store data that is related to the users, application, algorithms, process, etc. All storage elements described herein may include conventional memory and/or disk storage and may include a conventional database. A nonexhaustive list of more specific examples of storage medium includes the following: a cloud storage unit, portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

In one embodiment, each Computer Software application server 10 is a conventional SUN MICROSYSTEMS T SERIES SERVER running the ORACLE SOLARIS 11 or higher operating system commercially available from ORACLE CORPORATION of Redwood Shores, Calif., an Amazon Elastic Compute Cloud (EC2) instance running any operating system commercially available from Amazon Web Services, Inc. Calif., a PENTIUM-compatible personal computer system such as are available from DELL COMPUTER CORPORATION of Round Rock, Tex. running a version of the WINDOWS operating system (such as XP, VISTA, 7, 8, 10 or 11) commercially available from MICROSOFT Corporation of Redmond Wash. or a Macintosh computer system running the OS X operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each Computer Software application server 10 may also be a SAMSUNG GALAXY S22 commercially available from SAMSUNG ELECTRONICS GLOBAL of Seoul, South Korea running the ANDROID operating system commercially available from GOOGLE, INC. of Mountain View, Calif or an iPhone (5, 5S, 8, 8 Plus, X, XS Max, XR, SE, 11, 11 Mini, 11 Pro, 11 Pro Max, 12, 12 Mini, 12 Pro, 12 Pro Max, 13, 13 Mini, 13 Pro, 13 Pro Max, 14, 14 Mini, 14 Pro, 14 Pro Max) commercially available from APPLE INCORPORATED of Cupertino, Calif. Alternatively, such a Computer Software application server may also be achieved by any suitable hardware, component, device, application specific integrated circuit (ASIC), additional software, field programmable gate array (FPGA), server, processor, algorithm, erasable programmable ROM (EPROM), electrically erasable programmable ROM (EEPROM), or any other suitable object that is operable to facilitate such operations. Various combinations of Computer Software application servers may be employed, with the Computer Software application servers communicating with one another, user devices 30 or the external storage 20 via the network 40, a conventional cellular telephone network, an Ethernet network, universal bus connector or all of these.

Data or program instructions described herein can be shared and downloaded to respective application servers 10, user devices 30 or external storage devices 20 from each other via a network, for example, the internet, a local area network, a wide area network and/or a wireless network. In other embodiments, network 40 could be any packet data network offering a communications interface or exchange between any two nodes in the system. Network 40 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment, including a combination of any networks or systems described above. In various embodiments, network 40 may include, but are not limited to, wired and/or wireless mediums which may be provisioned with routers and firewalls. The network may comprise copper transmission cables, optical transmission fibers, wireless transmission, routers, firewalls, switches, gateway computers and/or edge servers. A network adapter card, network module or network interface in each computing/processing device such as the application server, storage or user devices receive computer readable program instructions from the network and forwards the computer readable program instructions for storage in a computer readable storage medium within the respective computing and/or processing device. A representative smart device, making up one or more of user devices 30. All elements of a system include an input 32, an output 33 or both. Other system elements may also include a conventional processor. Each User device 30 includes a conventional communication interface 36, such as a TCP/IP-compatible communication interface running suitable communication protocols, such as TCP/IP, Ethernet or others and is coupled to network 40 via network communication interface 36. Network 40 may include a conventional Ethernet network, the networks that make up the Internet, cellular communication networks, or any or all of these. Network 40 could be a plain old telephone system (POTS). Unless otherwise specified, all communication into or out of application server 10, user devices 30, or external storage 20 is made via network interface 40.

In some embodiments of the invention a system and a method for controlling a graphical user interface 300 of application is provided. The graphical user interface 300 can be presented to the user on the user device 30 via an output device 33 such as a display, printer, computer screen, a portable screen or any other such visual methods. The graphical user interface 300 enables the system to provide information such as instructions, data, or other information to the user of the system and then allows him or her to communicate with the application server and other users. Input device 32 such as a computer keyboard, mouse, touch screen or all allows user input to the user device 30. The touch screen interface may be used to detect and receive touch input such as a tap or a swiping gesture. Storage 34 inside the user device 30 may be used to store program instructions or user data or both. Separate external storage 20, such as a mobile disk drive or other non-volatile storage, may provide storage of data or program instructions as well. In one embodiment, external storage 20 provides longer term storage of instructions and data, with storage 504 providing storage for data or instructions that may only be required for a shorter time than that of external storage 20. External storage 20 can also be used to store data that is related to the users, application, algorithms, process, etc. All storage elements described herein may include conventional memory and/or disk storage and may include a conventional database. A location module 35 may be implemented using any suitable combination of hardware, firmware, and software. The location module can be used to retrieve the GPS coordinates of the device on which the application is running from the GPS system. GPS system is a conventional GPS system of a smart device), available IEEE 802.11 networks, and cellular radio signals, that obtains the GPS signals and identifies the coordinates of the device using the GPS signals or other information it may receive. In some embodiments, the location of the device can also be determined by using cellphone-based triangulation techniques, Wi-Fi based positioning system, or network addresses assigned by a service provider. As another example, Uplink Time Difference of Arrival (U-TDOA) may be used by location module 35 to determine location information. In some embodiments, location module 35 may determine location information using input from a user (such as users 1-100). For example, location module 35 may use user input as one factor in determining location and rely on other technologies to determine the location of the device. As another example, location module 35 may allow user 1 to specify location information (i.e., an intersection, an address, or a business). A user may specify location information by selecting location information from a list or map provided by location module 35. In some embodiments, users may manually submit their historical location information, current location information, or future location information from a device such as a mobile computer device. Users 1-100 may specify particular locations, location areas, and/or location types to include in his or her location information. In some embodiments, the user device 30 can be implemented via a PENTIUM-compatible personal computer system such as are available from DELL COMPUTER CORPORATION of Round Rock, Tex. running a version of the WINDOWS operating system (such as XP, VISTA, 7, 8, 10 or 11) commercially available from MICROSOFT Corporation of Redmond Wash. or a Macintosh computer system running the OS X operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each user device 30 may also be a SAMSUNG GALAXY S22 commercially available from SAMSUNG ELECTRONICS GLOBAL of Seoul, South Korea running the ANDROID operating system commercially available from GOOGLE, INC. of Mountain View, Calif or an iPhone (5, 5S, 8, 8 Plus, X, XS Max, XR, 11, 11 Mini, 11 Pro, 11 Pro Max, 12, 12 Mini, 12 Pro, 12 Pro Max, 13, 13 Mini, 13 Pro, 13 Pro Max, 14, 14 Mini, 14 Pro, 14 Pro Max) commercially available from APPLE INCORPORATED of Cupertino, Calif.

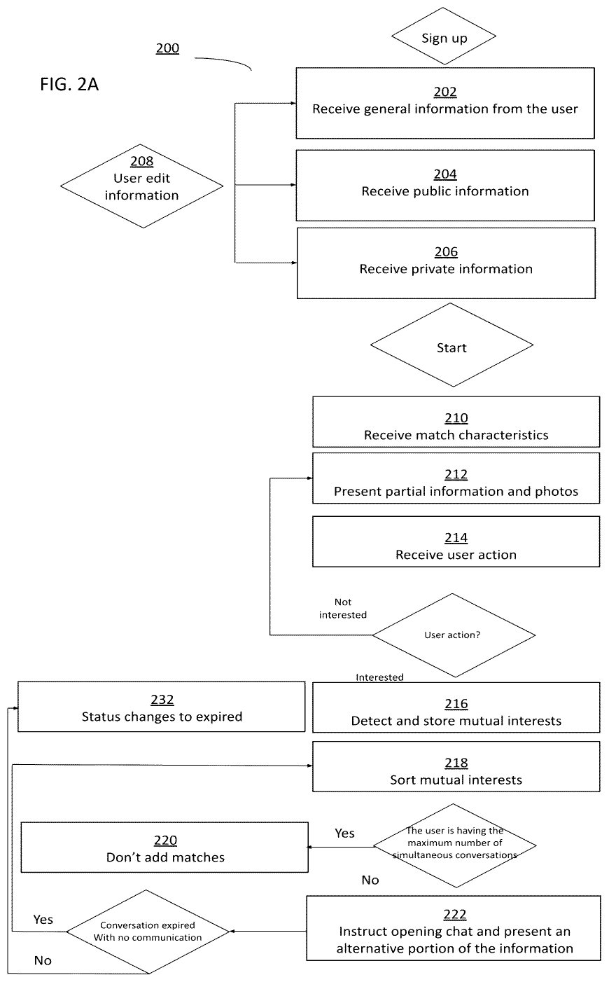

Referring now to FIGS. 2A and 2B, taken together, a flowchart illustrating a method 200 of controlling a graphical user interface (GUI) 300 of a matchmaking software application, is shown according to some embodiments of the invention. User photos and characteristics values for each of several characteristics are received from each of the users 202. User characteristics may include, but not limited to, age, education level, profession, height, gender, sexual preference, interests, knowledge of languages, etc., and the values may include a value for each characteristic, such as the actual age, actual height, etc. The characteristics and their values may be received in a question and answer format, with the user providing the values by selecting them from a list or another visual illustration or entering them by typing. The receipt of characteristics and values may be performed as an independently running process that any number of users may use or update at any time 208.

User public information is received from each of the users 204. User public information may include, but not limited to, additional information, music or cinema preference, etc., that the user wants to share with those who review his or her profile on public profile page 301. The receipt of the user's public information may be performed as an independently running process that any number of users may use or update at any time 208. Hereinafter, the photos and some information from step 202 and the information from step 204 are considered as public profile.

User private information is received from each of the users 206. User private information may include, but not limited to, additional information, music or cinema preference, etc., that the user wants to share with those who he or she is conversing with. The receipt of the user's private information may be performed as an independently running process that any number of users may use or update at any time 208. Hereinafter, some information from step 202 and the information from step 206 are considered as private profile.

In some embodiments, the public profile and the private profile may include some elements that are mutual.

In some embodiments, the user may control the exposure of elements of an associated third-party application, such as social media, streaming, etc., and to present information and/or other content from these third-party applications on the public and/or private profile.

Each user may specify match characteristics 210, i.e., characteristics of other users that user would like to converse with. For example, a woman may specify that she is interested only with man, within a certain geographic distance from her location, within a certain age, and that speaks only certain languages. The receipt of these characteristics' values may be performed as an independently running process that any number of users may use or update at any time. In one embodiment, a fee is required to specify some of match characteristics.

In some embodiments of the invention, processor 12 is configured to execute code for receiving GPS location data from a user's device 30 and for presenting to this user profiles according to the location data.

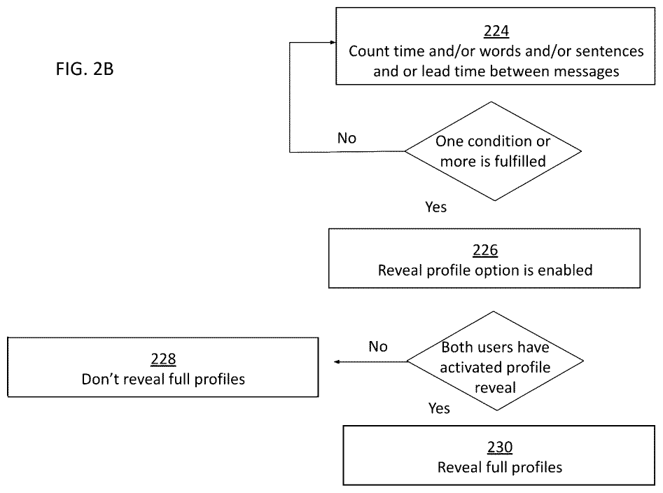

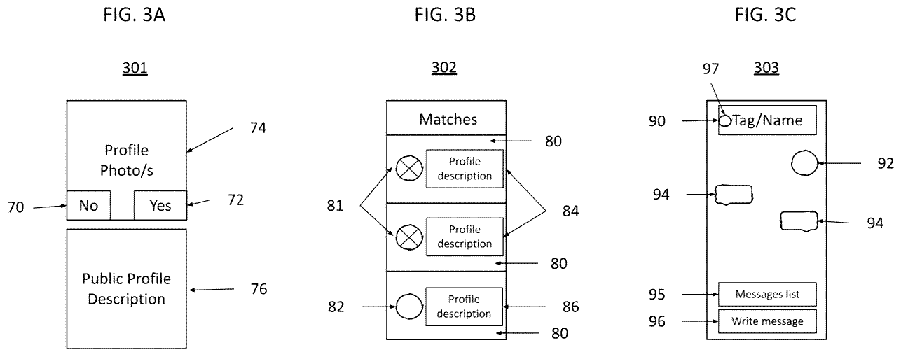

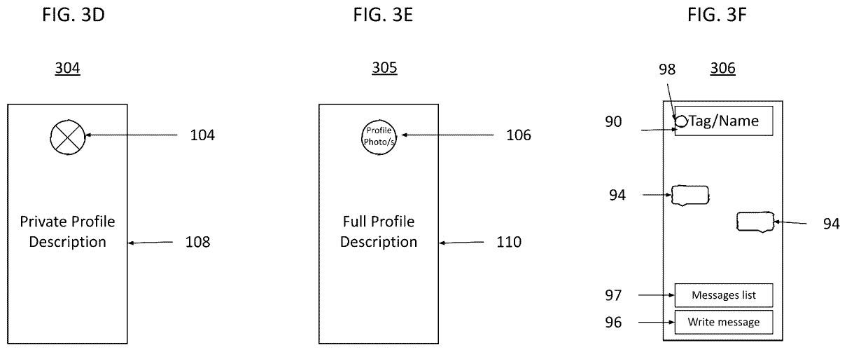

Each user is presented with public profiles of other users 212. Each public profile may include general information and photos of user 202, and user public information 204. For example, public profile page 301 shown in FIG. 3A includes a photo 74 of the associated user and a description 76 that may include, but not limited to, self-description and/or biographical details and/or personal preference on various topics. Photo 74 is the position of which all the photos of the corresponding user are presented, one photo at a time. The order of the presented photos is determined by the user who uploaded them, while the photo that is ordered as the first one is considered to be the main profile photo. The user who reviews the photo can switch from one photo to another by scrolling between them and/or by other motion and/or clicking. At any time, any number of users may provide an indication of an action they wish to take, and such action is received 214. In case the user action is that he or she is not interested in the presented profile, an indication of lack of an interest is recorded and another profile is presented instead. In case the user action is that he or she is interested in the presented profile, an indication of such an interest is recorded and another profile is presented instead. In some embodiments of the invention, the processor 12 is configured to execute code for replenish reviewed profiles of profiles of no interest, so they could be reviewed again in case a condition is fulfilled and/or the user chooses to review these profiles.

Referring now to FIG. 1B, which depicts an embodiment in which application server 10 has a registered users database 50 which contains a pool of registered users 52. Each entry in database 50 has a pool entity 52 along with information concerning that entity. In one embodiment, each pool entity 52 represents a user and their profile. In some embodiments' not all registered users are in pool 52.

In some embodiments, profile page 301 includes buttons 72 and 70 for indication whether the profile interests the user or not, respectively. In other embodiments, one button may suffice for indication that the profile interests the user. In other embodiments, other manners of indication may be used, such as, for example, a swiping motion on a touch screen.

In case there is a mutual interest between the user and the user of interest, the mutually interest users will be detected and stored for each user in mutual interest database 60 that contains a pool of all the users the user has mutual interest with 216, as shown in FIG. 1C. Each entry in mutual interest database 60 has a matched entity 62 along with information concerning that entity. In one embodiment, each matched entity 62 represents a user and their profile.

Every predetermined period of time, mutual interest database 60, which contains the mutually interest users of each user, is sorted 218 based on a compatibility score 65 that is given to each pair of users. The higher the compatibility score 65 the higher the user will be ranked on mutual interest list of the user of interest. In some embodiments, compatibility score 65 may be computed, but not limited to, based on the mutually interested user characteristics and their values, popularity, number of users they speak with simultaneously on the system, number of messages exchanged with each user of interest, number of words exchanged with the each user of interest, response time between the time a message was read and another message that was sent by the reading user, the mutually interest users behaviors on the system, any other suitable data and/or any calculations that use some or all of these.

In some embodiments, popularity of a user may be determined, but not limited to, by the number of users who are interested in the user, the ratio between the number of users who are interested in the user and the total number of users who reviewed the profile of the user, number of simultaneous conversations the user has and/or usually has, number of mutually interested users, and/or any calculations that use some or all of these.

In some embodiments, system 100 may decide which profiles of users are prioritized in mutual interest database 60 of a certain user based on data of other users with similar mindset. The data of other users with similar mindset may be, but not limited to, the mutually interested user characteristics and their values, popularity, number of users they speak with simultaneously on the system, number of messages exchanged with each user of interest, number of words exchanged with each user of interest, response time between the time a message was read and another message that was sent by the reading user, the mutually interest users behaviors on the system, any other suitable data and/or any calculations that use some or all of these.

In some embodiments, users are limited with the number of users they can be matched with and/or converse with simultaneously. Users can be matched and/or converse with less, but not more than, a predetermined number of people at any given time. In case a user has reached the predetermined number of conversations, he or she is not paired with another user 220 and the system will check the next user in the mutual interest database 60. In case a user has not reached the predetermined limit of conversations, a private profile and conversation will be presented to them 222. In some embodiments, each private profile may include general information of user 202, and user private information 206. The new profile is provided from the sorted list of mutually interest users 218. Such mutually interest users that are matched and can converse with each other are called matched users.

In some embodiments, the sorting 218 is being done only for users that their status on mutual interest database 60 is not active nor expired. For example, when a user initiated a conversation, or initiated a conversation with another user and the conversation has expired, then these users are not sorted on mutual interest database 60 and are not to be matched with users again. In one embodiment, in case a conversation between matched users has expired and no communication had occurred between the users until it expired, then the status of the user will change back to pending and these users could be matched again.

The instruction of presenting a new private profile and initiating a new conversation 222 does not happen immediately after the detection of mutually interest users, but only after, no less, then a predetermined period of time. For example, once a day every 12 hours or once a day at 08:00 (AM). For example, as shown schematically in FIG. 3B a representation icon 81 and user characteristics 84 appear on the matches page 302 for each matched user until the full profiles are revealed. User characteristics may include, but not limited to, age, education level, profession, height, gender, sexual preference, interests, knowledge of languages, etc., and the values may include a value for each characteristic, such as the actual age, actual height, etc. In some embodiments, when the instruction of presenting a new private profile and initiating a new conversation 222 happens, the matched users' status on each other's mutual interest database 60 changes to active. In case a user removes the other matched user from his or her matches page or in case the conversation has expired, the matched users' status on each other's mutual interest database 60 changes to expired 232. In other embodiments, additionally or alternatively, when the instruction of presenting a new private profile and initiating a new conversation 222 happens, the matched users are removed from each other's mutual interest database 60 and appear only on matched users list, or in case the user removed the matched user, on expired list.

As used herein, a conversation may be an exchange of information between users during a chat such as an instant messaging chat, a voice call, or a video call. In some embodiments, where the conversation is voice or video call, condition, or more, can be evaluated by converting speech data into text, using a voice to text module and applying functions for evaluating quantity or quality of the conversation on the text. In some embodiments, video call is available only in case the full profiles are revealed by the matched users.

In some embodiments of the invention, users may choose to perform the anonymous conversation by Voice-Over Internet Protocol (VOIP) call instead of messaging conversation. Hereinafter, anonymous conversation refers to the period of which only private profile 304 is revealed to the matched user. In case full profile 305 is revealed to the matched user, it is not considered as anonymous conversation.

In some embodiments, once a conversation is generated, the matched users have a predetermined period of time to converse with each other. If a user wants to extend this time, he or she can decide to do so by extending the conversation by one, or more, predetermined period of time. For example, the matched users have 7 days to converse once the conversation is generated and can extend it by another 3 days.

In some embodiments, in case neither one of the participating users initiated a conversation or decided to end the conversation and to remove the other user from their matched page 302 by the time the conversation is expired, the user information will return to mutual interest database 60 and will be part of step 218 again. In some embodiments, only once a predetermined condition, or more, is fulfilled the user will be eligible to get matched again with the user of which the conversation was expired with no messages.

In case a user wants to initiate or continue a conversation with a matched user, the user clicks on card 80 of the specific user they want to converse with, and a corresponding conversation is opened. A schematic illustration of an exemplary conversation page 303 of GUI 300 is shown in FIG. 3C. Clicking on the card 80 opens a conversation page 303 that may include a text box 94 showing the conversation, and input field 96 for entering a message.

In some embodiments, conversation page 303 may include list 95 that contains predetermined messages. User may choose a message to send from a predetermined messages list. In case a user chooses a message from the predetermined messages list, the message text is copied to the input field 96 and the user can send the message.

Conversation page 303 may include a tag 90 associating the conversation with the participating profile of interest without revealing the associated profile, such as a name, nickname, thumbnail, code, and/or any other suitable tag that doesn't reveal to the user the respective full profile. Additionally or alternatively, conversation page 303 may include a corresponding representative icon 97. In some embodiments, in case the profiles are not revealed, and a user clicks on the participating profile of interest's tag 90, the corresponding private profile page of the participating profile of interest 304 is opened. A schematic illustration of an exemplary private profile page is shown on FIG. 3D. In some embodiments, private profile page 304 may include, but not limited to, a representation icon 104 and private profile description 108. Representation icon 104 and representation icon 97 may look identical to representation icon 81 but they may have different dimensions or the same.

In some embodiments, private profile description 108 on private profile page 304 may include, but not limited to, the corresponding user characteristics, private information that the user decides to share only with those he or she matched with, preference of any kind, etc. For instance, FIG. 6 is a screenshot of a private profile having a masked image that is presented during the conversation, before the profile was revealed. Optionally, the masked image is used as a graphical object indicative of progress to fulfill the conditions to reveal the full profiles of the matched users.

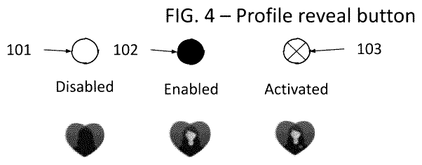

Referring back to FIG. 3C, conversation page 303 may include a reveal profile button 92, which a user may use for notifying system 100 that he or she is requesting to reveal their profile. Reveal profile button 92 has three modes with three corresponding icons as shown in FIG. 4: disabled icon 101, enabled icon 102 and activated icon 103. In some embodiments, reveal profile button 92 is disabled since a new profile is generated and until the matched users fulfill one, or more, predetermined conditions. In case the matched users fulfill one, or more, predetermined conditions, disabled icon 101 changes to enabled icon 102 and the users can select request to reveal the full profile with the participating user. In case a user requested to reveal the full profile with the participating user enabled icon 102 changes to activated icon 103.

In some embodiments, the anonymous period of time lock of the matched users may be determined according to, but not limited to, one or more of the following: the number of sent messages by each user participating in the conversation, the number of words within each of these messages, response time between the time a message was read and another message that was sent by the reading user. Once a condition, or more, is fulfilled, each user can select to reveal their full profile 226. Once a conversation between two matched users is opened processor 12 starts to count the number of sent messages by each user participating in the conversation, the number of words within each of these messages, response time between the time a message was read and another message that was sent by the reading user. In some embodiments, the anonymous period of time lock of the matched users may be determined according to the sentiment of the conversation. System 100 analyzes the terms used in the conversation to assess the sentiment of the matched users with regard to each other and may change the conditions to end the anonymous period of time lock of the matched users. For example, system 100 will require less exchanged messages between the matched users in case the assessed sentiments are mutually positive, and/or decrease the required response time between the time a message was read and another message that was sent by the reading user in case the assessed sentiments are mutually negative.

In some embodiments, the predetermined conditions to enable the option to request to reveal the full profile of matched users may change between different pairs of matched users based on their characteristics, number of users they speak with simultaneously on the system, number of messages exchanged with the specific user of interest, number of words exchanged with the specific user of interest, number of messages exchanged with all users of interest, number of words exchanged with all users of interest, response time between the time a message was read and another message that was sent by the reading user, sentiment analysis, the matched users behaviors on the system, any of these of users with similar mind set and/or any other suitable data and/or calculations that use some or all of these.

In some embodiments, in case only one user of the matched users selects to reveal the full profile, none of the two profiles is revealed 228. For example, on conversation page 303 profile reveal button 92 changes from enabled icon 102 to activated icon 103 for the users who decided to select to reveal the full profile, while for the other user enabled icon 102 is still presented.

In some embodiments, in case both users of the matched users select to reveal the full profile, the full profile of each user of the matched users is revealed 230. The full profile of each user includes all the information and photos that are included in the public profile and all the information that is included in the private profile. For example, as shown schematically on FIG. 3B a revealed representation icon 82 and a revealed description 86 appear on the matches page 302 for each matched user as the profiles are revealed. Once icon 81 and/or representation icon 104 change to revealed icon 82 and revealed representation icon 106, respectively, a user may view the respective full profile and/or return to conversation with a revealed profile at any time, for example by clicking on the icon 82 and/or representation icon 98.

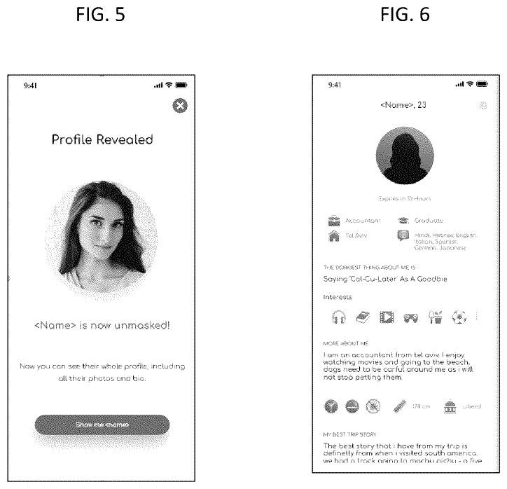

In some embodiments, in case the profiles of the matched users are revealed 230 reveal profile button 92 may be removed from the conversation page 303, as shown schematically in FIG. 3F, on reveal conversation page 306. Optionally, a GUI window indicating the matched user full profile is now available to be reviewed by the user, for instance as depicted in FIG. 5.

In some embodiments, revealed conversation page 306 may include, but not limited to, a representation icon 98 that may look identical to revealed representation icon 82 and/or revealed representation icon 106 but they may have different dimensions or the same.

In some embodiments, representation icon 98 revealed representation icon 82 and/or revealed representation icon 106 may be a representation of the main profile photo of the user.

In some embodiments, the matched users can share the contact information only after they revealed their full profiles to each other. Contact information may include, but not limited to, phone number, mobile number, email address, social media address and/or etc.

At any time, users can decide to end the conversation and to remove the other user from their matched page 302. Once a user is removed, the user profile card 80 is removed from matched page 302 and this pair of users is not able to communicate again via the system.

The methods as described above are used in the fabrication of integrated circuit chips.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms “comprises”, “comprising”, “includes”, “including”, “having”, and their conjugates mean “including but not limited to”. This term encompasses the terms “consisting of” and “consisting essentially of”.

The phrase “consisting essentially of” means that the composition or methods may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

What is claimed is:

1. A system for controlling a graphical user interface (GUI), the system comprising a processor configured to execute code for:
receiving indications from multiple users about profiles of interest presented to the users by a GUI executed on respective devices of the users, wherein each user has corresponding profile information presentable by the GUI; detecting couples of mutually interested users that indicated each other's profiles as profiles of interest; for each couple, once a predetermined condition, or more, is fulfilled, adding in the GUI an anonymous/alternative representation of a matched user in a match page of the other matched user, and initiating a conversation between the matched users by opening a conversation in the matches page in the GUI, wherein the anonymous/alternative representation conceals the represented user's full/public profile from the other user; and
once a predetermined condition, or more, is fulfilled, changing the anonymous/alternative representation to a full representation by loading all the profile information and/or photos of the represented user to the match page.

2. The system of claim 1, wherein the conversation is held in a voice call established between the matched users; wherein the voice call is analyzed by an audio analysis to determine a compliance with at least one predetermined condition.

3. The system of claim 1, wherein the conversation is held in an audio call established between the matched users; wherein a video call is enabled based on a compliance with at least one predetermined condition or more.

4. The system of claim 1, wherein the processor is configured to count time and/or number of words by one or more of the users and/or number of messages and/or lead time between messages, and the conditions are combinations of these parameters; wherein the required number of words and/or messages is at least one of a list comprising varying dynamically based on predetermined conditions, depending on a number of open conversations a user has with profiles of interest, depending on a sentiment of the conversation and depending on the continuousness of the conversation.

5. The system of claim 3, wherein the processor is configured to execute code for receiving a response by a user participating in the conversation to reveal his or her full profile, and deciding whether to reveal the participating users full profiles based on the mutual request to reveal, and instructing the presentation of the participating users full profiles.

6. The system of claim 1, wherein the conversation page includes an anonymous Voice-Over Internet Protocol (VOIP) call.

7. The system of claim 1, wherein the conditions until revealing are reduced faster as the conversation is more active.

8. The system of claim 1, wherein the conversation page includes a button for requesting revealing of the users participating in the conversation profiles.

9. The system of claim 1, wherein the anonymous representation includes an icon representing an unrevealed profile of the other one of the matched users, wherein selection of the icon causes opening of the conversation page at the GUI for conversation between the matched users.

10. The system of claim 1, wherein the processor is configured to execute code for, adding an anonymous icon of a matched user in a matches page, wherein selection of the icon opens a conversation page at the GUI for conversation between the matched users wherein the matches page includes additional icons representing unrevealed profiles of other users matched in the device's user, with which a conversation was initiated, the icons are presented on the matches page as a gallery of icons, enabling the user to review all his or her conversations.

11. The system of claim 1, wherein the processor is configured to execute code for deciding which profiles are provided to the user to have a conversation based on at least one of a list comprising: user preferences, the profiles' users selections, selections of users with similar mindset mutually interested user characteristics and their values, popularity, number of users they speak with simultaneously on the system, number of messages exchanged with each user of interest, number of words exchanged with the each user of interest, number response time between the time a message was read and another message that was sent by the reading user, the mutually interest users behaviors on the system, any other suitable data and/or any calculations that use some or all of these.

12. The system of claim 1, wherein the processor is configured to execute code for dividing reviewed profiles in two groups of profile cards, one for profiles of interest and one for profiles of no interest, wherein the profiles of no interests may be reviewed again once a predetermined condition, or more, is fulfilled.

13. The system of claim 1, wherein the processor is configured to execute code for receiving location data from a user's device and for presenting to this user profiles according to the location data.

14. A method for controlling a GUI, the method comprising:
receiving indications from multiple users about profiles of interest presented to the users by a GUI executed on respective devices of the users, wherein each user has corresponding profile information presentable by the GUI; detecting couples of mutually interested users that indicated each other's profiles as profiles of interest; for each couple, once a predetermined condition, or more, is fulfilled, adding in the GUI an anonymous/alternative representation of a matched user in a match page of the other mutually interested user, and initiating a conversation between the matched users by opening a conversation in the matches page in the GUI, wherein the anonymous/alternative representation conceals the represented user's full/public profile from the other user; and once a predetermined condition, or more, is fulfilled, changing the anonymous/alternative representation to a full representation by loading all the profile information and/or photos of the represented user to the match page.
